(19) United States
(12) Patent Application Publication
(10) Pub. No.: US 2017/0241592 A1
(43) Pub. Date: Aug. 24, 2017

(54) SYSTEM AND METHOD FOR REFUELLING A COMPRESSED GAS PRESSURE VESSEL USING A COOLING CIRCUIT AND IN-VESSEL TEMPERATURE STRATIFICATION

(71) Applicant: MOSAIC TECHNOLOGY DEVELOPMENT PTY LTD, Brisbane, Queenland (AU)

(72) Inventors: Paul Anthony Whiteman, BRISBANE (AU); Derek Shane Fekete, BRISBANE (AU)

(21) Appl. No.: 15/518,460

(22) PCT Filed: Oct. 13, 2015
(86) PCT No.: PCT/AU2015/050623

§ 371 Date: Apr. 11, 2017

(30) Foreign Application Priority Data
Oct. 14, 2014 (AU) 2014904104

(51) Int. Cl. F17C 5/00; F17C 13/02; F17C 5/06

(52) U.S. Cl. CPC F17C 5/007; F17C 5/06; F17C 13/026; F17C 2201/035; F17C 2205/035; F17C 2205/0352; F17C 2205/0391; F17C 2221/033; F17C 2223/0123; F17C 2225/0123; F17C 2225/036; F17C 2225/041; F17C 2227/036; F17C 2250/01; F17C 2270/0139; F17C 2270/0171; F17C 2270/0176; F17C 2270/0178; F17C 2227/0337

(57) ABSTRACT

A pressure vessel refuelling system enables fast fill refuelling of CNG fuel tanks by inducing a stratification of gas temperatures inside a tank during refuelling, then re-cycling a portion of the relatively warmer gas out of the tank during refuelling and back to a gas chiller. The system includes a pressure vessel having a lower end, a first gas port and a second gas port, wherein the second gas port is positioned above the lower end of the pressure vessel; and a cooling circuit connecting the first gas port with the second gas port; whereby gas flowing from an interior cavity of the pressure vessel through the second gas port is cooled in the cooling circuit before returning to the pressure vessel through the first gas port; and whereby a temperature of gas inside the pressure vessel varies from a first temperature at a level of the lower end of the pressure vessel to a second temperature, which is higher than the first temperature, at a level of the second gas port.

### FIELD OF THE INVENTION

This invention relates generally to a compressed gas transfer system. In particular, the invention relates to a compressed natural gas (CNG) transfer system including a cooling circuit and in-vessel temperature stratification to manage temperature rises.

### BACKGROUND OF THE INVENTION

Natural gas fuels are relatively environmentally friendly for use in vehicles, and hence there is support by environmental groups and governments for the use of natural gas fuels in vehicle applications. Natural gas based fuels are commonly found in three forms: Compressed Natural Gas (CNG), Liquefied Natural Gas (LNG) and a derivative of natural gas called Liquefied Petroleum Gas (LPG).

Natural gas fuelled vehicles have impressive environmental credentials as they generally emit very low levels of SO₂ (sulphur dioxide), soot and other particulate matter. Compared to gasoline and diesel powered vehicles, CO₂ (carbon dioxide) emissions of natural gas fuelled vehicles are often low due to a more favourable carbon-hydrogen ratio found in natural gas. Natural gas vehicles come in a variety of forms, from small cars to buses and increasingly to trucks in a variety of sizes. Natural gas fuels also provide engines with a longer service life and lower maintenance costs. Further, CNG is the least expensive alternative fuel when comparing equal amounts of fuel energy. Still further, natural gas fuels can be combined with other fuels, such as diesel, to provide similar benefits mentioned above.

A key factor limiting the use of natural gas in vehicles is the storage of the natural gas fuel. In the case of CNG and LNG, the fuel tanks are generally expensive, large and cumbersome relative to tanks required for conventional liquid fuels having equivalent energy content. In addition, the relative lack of wide availability of CNG and LNG refuelling facilities, and the cost of LNG, add further limitations on the use of natural gas as a motor vehicle fuel. Further, in the case of LNG, the cost and complexity of producing LNG and issues associated with storing a cryogenic liquid on a vehicle further limit the widespread adoption of this fuel.

While LNG has had some success as a liquid fuel replacement in some regions of the world, the lack of availability of LNG and its high cost means that in many regions of the world it is not a feasible alternative fuel. In the case of CNG, it also has had some success as a liquid fuel replacement but almost exclusively in spark ignition engines utilising low pressure carburetted port injection induction technology. This application is popular in government bus fleets around the world where the cleaner burning natural fuel is used in a spark ignition engine fitted in place of a conventional diesel engine.

Some of the above issues are also mitigated when using LPG, and this fuel is widely used in high mileage motor cars such as taxis. However, cost versus benefit comparisons are often not favourable in the case of private motor cars. Issues associated with the size and shape of the fuel tank, the cost variability of LPG and the sometimes limited supply mean that LPG also has significant disadvantages that limit its widespread adoption. In summary, unless there is massive investment in a network of LNG plants around major transport hubs, CNG is the only feasible form of natural gas that is likely to be widely utilised in the near future.

However, some technical problems still limit the efficiency of CNG fuel systems. For example, the pressure to which composite CNG cylinders can be filled at a typical CNG re-fuelling station is limited because the heat of compression can cause overheating of cylinders being filled. This has typically meant that 245 bar at 21 degrees Celsius (settled temperature) is the limit for composite CNG cylinder filling, and has become the standard adopted in many parts of the world including the US.

In the US, codes typically allow for filling to an overpressure of 1.25 times the pressure rating of the CNG cylinder provided it would subsequently settle to 245 bar if cooled to 21 deg. C. The code also identifies in-cylinder heating as having the potential to cause transient temperature excursions exceeding cylinder design parameters. This limits current filling practices of CNG cylinders, such that fills of between 70% and 80% of cylinder “name plate” ratings are often all that can be achieved. This has a significant detrimental impact on the range of CNG vehicles, and also on consumers who often have difficulty understanding the variability of a CNG cylinder fill and the impacts on vehicle range.

Also, the variability and inability to fully fill CNG cylinders has a major impact on the use of CNG cylinders in bulk gas transport, where poor CNG cylinder filling has significant commercial impact on the cost of gas delivered.

For example, in Europe, the relevant codes limit the maximum pressure in composite CNG cylinders during re-fuelling to 260 barg to ensure maximum design temperatures are not exceeded. These limitations meant that the currently available composite cylinders designed for 350 barg operating pressure and above could not be utilised in conventional CNG re-fuelling systems. Thus the opportunity to utilise smaller CNG cylinders, or to achieve increases in vehicle range, or improved commercial outcomes for gas transport, using the same size fuel cylinders, can not be realised.

A further problem with current systems for refuelling large CNG vessels, such as used in buses and trucks, is that the size and weight of the refuelling connection makes them difficult to handle and problematic relative to the smaller connectors used commonly for filling cars.

International Patent Application Publication No. WO2008/074075, titled “A COMPRESSED GAS TRANSFER SYSTEM”, disclosed for the first time a liquid backpressure system that enables the complete filling of on-vehicle CNG fuel tanks at full pressures. However, with this system the delivery of liquid into and out of CNG cylinders limits the application of the technology, and can slow transfer rates due to an inability to fill cylinders in parallel.

International Patent Application Publication No. WO2014/094070, titled “SYSTEM AND METHOD FOR REFUELLNG A COMPRESSED GAS PRESSURE VESSEL USING A THERMALLY COUPLED NOZZLE” discloses a system that includes an in-tank nozzle. However, in some applications this system can require the use of substantive chilling and heat exchange equipment due to the sometimes low approach temperature of the gas to typical ambient conditions.

There is therefore a need for an improved system and method for refuelling compressed gas pressure vessels.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

In one form, although not necessarily the only or broadest form, the invention resides in a pressure vessel refuelling system, comprising:

a pressure vessel having a lower end, a first gas port and a second gas port, wherein the second gas port is positioned above the lower end of the pressure vessel; and

a cooling circuit connecting the first gas port with the second gas port;

whereby gas flowing from an interior cavity of the pressure vessel through the second gas port is cooled in the cooling circuit before returning to the pressure vessel through the first gas port; and

whereby a temperature of gas inside the pressure vessel varies from a first temperature at a level of the lower end of the pressure vessel to a second temperature, which is higher than the first temperature, at a level of the second gas port.

Preferably, the cooling circuit includes a plurality of pressure vessels connected in parallel in the circuit.

Preferably, the cooling circuit includes a first pressure vessel connected in series to a plurality of additional pressure vessels connected in parallel in the circuit.

Preferably, the first pressure vessel connected in series includes a nozzle in an interior cavity of the first pressure vessel, and the plurality of additional pressure vessels connected in parallel in the circuit do not include a nozzle in an interior cavity of the additional pressure vessels. Preferably, the cooling circuit includes a plurality of pressure vessels connected in series in the circuit. Preferably, an opening to the second gas port is positioned at an upper end of the pressure vessel using an extension pipe positioned inside of the pressure vessel.

Preferably, a nozzle is in fluid communication with the first gas port, whereby the nozzle and the pressure vessel are thermally coupled such that Joule-Thomson expansion of a gas flowing through the nozzle cools the interior cavity of the pressure vessel.

Preferably, the nozzle is a convergent-divergent (CD) nozzle.

Preferably, the nozzle is positioned in the interior cavity of the pressure vessel.

Preferably, the nozzle is positioned in the interior cavity of the pressure vessel and at the lower end of the pressure vessel.

Preferably, the nozzle is positioned in the interior cavity of the pressure vessel and spaced away from the first gas port.

Preferably, the nozzle is positioned outside the interior cavity of the pressure vessel and adjacent the first gas port.

Preferably, the pressure vessel is a compressed natural gas (CNG) vessel.

Preferably, the inlet pressure to the nozzle is maintained at a continuous high pressure to increase Joule-Thomson cooling.

Preferably, the pressure vessel is one of a plurality of pressure vessels used for the transport of compressed natural gas (CNG).

Preferably, the cooling circuit includes a gas chiller.

Preferably, the cooling circuit includes a secondary gas compressor.

Preferably, the cooling circuit includes a flow control valve whereby a gas recycle rate through the pressure vessel is controlled.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 illustrates a pressure vessel refuelling system, including a cooling circuit, which supplies gas at high pressure to CNG transport tanks, according to an embodiment of the present invention.

FIG. 2 illustrates another pressure vessel refuelling system, according to an alternative embodiment of the present invention.

Those skilled in the art will appreciate that minor deviations from the layout of components as illustrated in the drawings will not detract from the proper functioning of the disclosed embodiments of the present invention.

### DETAILED DESCRIPTION OF THE PREFERRED EMBODIMENT

Embodiments of the present invention comprise systems and methods for refuelling compressed gas pressure vessels using a cooling circuit and in-vessel temperature stratification. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the invention includes a pressure vessel refuelling system, including: a pressure vessel having a lower end, a first gas port and a second gas port, wherein the second gas port is positioned above the lower end of the pressure vessel; and a cooling circuit connecting the first gas port with the second gas port. Gas flowing from an interior cavity of the pressure vessel through the second gas port is cooled in the cooling circuit before returning to the pressure vessel through the first gas port. A temperature of gas inside the pressure vessel varies from a first temperature at a level of the lower end of the pressure vessel to a second temperature, which is higher than the first temperature, at a level of the second gas port.

Advantages of the present invention include enabling fast fill refuelling of CNG fuel tanks by inducing a stratification of gas temperatures inside a tank during refuelling, then re-cycling a portion of the relatively warmer gas out of the tank during refuelling and back to a gas chiller. That reduces the in-tank temperature rise caused by the heat of compression as gas is added to a tank. According to some embodiments the system thus enables a transport tank used in a CNG “virtual pipeline” to be quickly filled to its capacity pressure rating with managed temperature rise, eliminating the “partial fill” result of prior art processes for refuelling CNG tanks caused by the heat of compression significantly raising tank temperatures.

In this specification CNG cylinders that supply or store gaseous fuel are synonymously referred to as tanks, vessels, pressure vessels, CNG cylinders and cylinders.

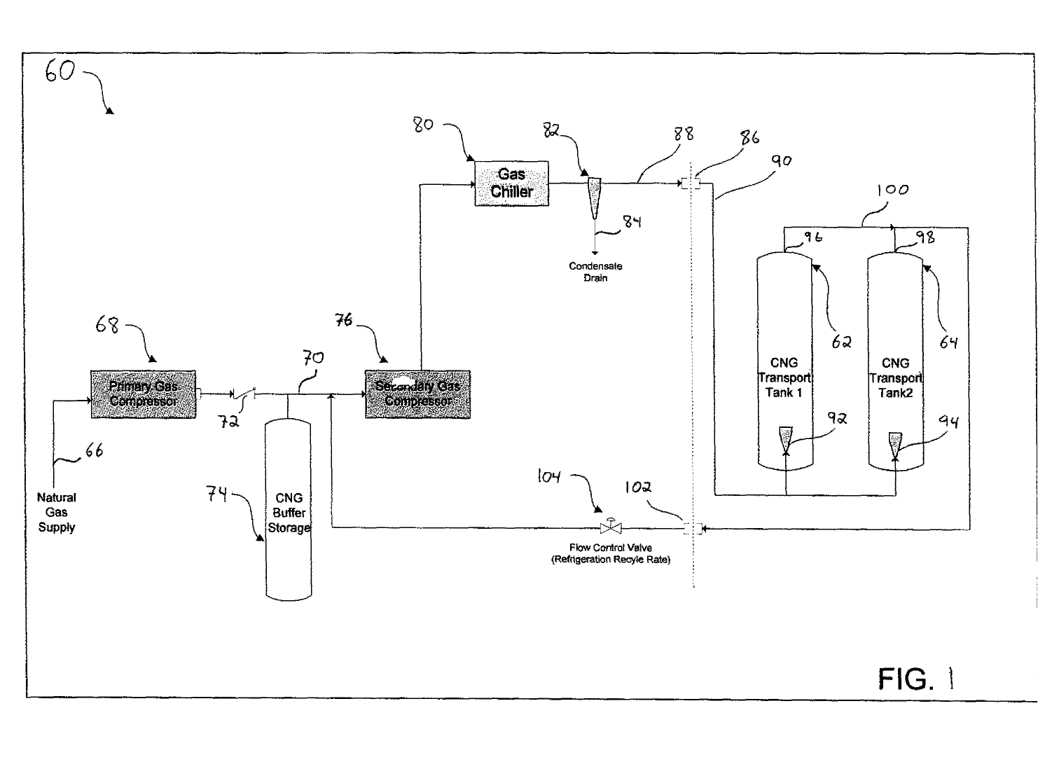

FIG. 1 illustrates a pressure vessel refuelling system 60, including a cooling circuit, which supplies gas at high pressure to CNG transport tanks 62, 64, according to an embodiment of the present invention. Natural gas enters the system 60 via a supply line 66 at a typical distribution pressure, such as 100-500 psig. The gas then enters a primary gas compressor 68 where it is compressed to a buffer storage pressure such as 3600 psig. A supply line 70 is connected to an output of the primary gas compressor 68 and includes a check valve 72. The supply line 70 supplies gas to both a CNG buffer storage vessel 74 and to a secondary gas compressor 76, which generally has a higher power capacity than the primary gas compressor 68. A supply line 78 is connected to an output of the secondary gas compressor 76 and is at a final supply pressure, such as 5000 psig.

A gas chiller 80 is used to pre-cool the gas before delivery to the tanks 62, 62. Downstream of the gas chiller 80, a gas coalescer 82 is used to remove excess aerosols from the gas, which are then removed through a condensate drain 84.

As will be understood by those skilled in the art, standard connectors, bleed valves, etc. are ordinarily included at an interface 86 between supply lines 88 and supply lines 90 that connect directly to the tanks 62, 64. The supply lines 90 are connected directly to nozzles 92, 94 positioned in an interior cavity of the tanks 62, 64. Joule-Thomson expansion of the gas thus occurs almost exclusively inside the tanks 62, 64, reducing overall gas temperature rises inside the tanks 62, 64 due to the heat of compression, as described above.

Further, as the nozzles 92, 94 are positioned at a lower end of the tanks 62, 64, the cooled gas entering the tanks 62, 64 tends to settle and remain at the lower end of the tanks 62, 64, whereas the relatively warmer and thus less dense gas already present in the tanks 62, 64 tends to rise to the upper end of the tanks 62, 64.

The tanks 62, 64 further include secondary outlet ports 96, 98 positioned at an upper end of the tanks 62, 64 and connected to a gas recycling line 100. An interface 102, including for example a check valve, bleed valves, etc. connects the recycle line 100 back to the supply line 70 and to an input of the secondary gas compressor 76. A flow control valve 104 enables a gas recycle rate from the tanks 62, 64 to the secondary gas compressor 76 to be controlled. By connecting the recycle line 100 to the supply line 70 that is maintained at the reduced pressure of the CNG buffer storage vessel 74, the compression energy required to circulate gas from the tanks 62, 64 and through the cooling circuit formed by the recycle line 100 is reduced.

According to embodiments of the present invention, the gas recycling line 100 thus closes a cooling circuit through the tanks 62, 64. During a refuelling process, the mass flow rate of gas into the tanks 62, 64 via the supply lines 90 exceeds the mass flow rate of gas out of the tanks 62, 64 via the gas recycling line 100. The tanks 62, 64 thus are refilled with gas while simultaneously the temperature rise of the gas from the heat of compression can be significantly reduced or eliminated using the cooling circuit that extracts heat from the system 60 through the gas chiller 80.

Further, because only the relatively warmer gas from the upper end of the tanks 62, 64 is expelled through the secondary outlet ports 96, 98, the cooling circuit is more efficient than would be the case if relatively cooler gas from the lower end of the tanks 62, 64 was circulated through the cooling circuit. As is well known in the art, the efficiency of a cooling circuit transferring heat from a hot reservoir to a cold reservoir is increased when the temperature difference between the reservoirs is increased. The increased temperature difference to ambient in the cooling circuit, in many cases, makes possible heat rejection directly to ambient air without the need for cooling towers or expensive refrigeration.

The embodiment illustrated in FIG. 1 is particularly useful for “virtual pipeline” applications, where banks of numerous CNG storage vessels are installed in a shipping container or other transportation configuration to enable transport of CNG gas from a main supply source to local distribution facilities.

As understood by those skilled in the art, and following basic fluid dynamics principles concerning nozzles, supersonic flow is initiated through the nozzles 92, 94, causing gas flow in the nozzles 92, 94 to be “choked”. Because the supersonic flow near a throat of the nozzles 92, 94 prevents pressure waves from travelling upstream of the nozzles 92, 94, the mass flow rate through the nozzles 92, 94 is generally unaffected by changes in downstream pressure, even as the pressure in the fuel tanks 62, 64 steadily increases.

Further, Joule-Thomson expansion of the gas across the nozzles 92, 94, causes the gas entering the tanks 62, 64 to substantially cool. However, simultaneously the heat of compression of the gas already inside the fuel tanks 62, 64 tends to cause the gas temperature to increase. The result, according to embodiments of the present invention, is that an overall temperature rise of gas in the tanks 62, 64 during the refuelling process is substantially moderated compared to the prior art. Initial cooling of the gas at the gas chiller 80 further assists in decreasing the temperature rise of the gas during the refuelling process.

The nozzles 92, 94 can be of various designs, including for example conventional convergent-divergent (CD) nozzles. Alternatively, each nozzle 92, 94 can be replaced by a simple orifice. If the orifices are adequately small, pressure inside the high pressure supply lines 90 can be maintained at or near the storage pressure, such as 5000 psig, and thus most Joule-Thomson expansion and the associated Joule-Thomson cooling of the supplied gas will occur inside the fuel tanks 62, 64 and not in the high pressure supply lines 90.

The nozzles 92, 94 are positioned inside the tanks 62, 64 and away from the interior surfaces of the tanks 62, 64. That prevents localised intense cooling from Joule-Thomson expansion of the gas severely cooling and possibly compromising the structural integrity of sides of the tanks 62, 64. Any ice or hydrates that form on the divergent section of the nozzles 92, 94 is simply blown off the nozzles 92, 94 by the gas flow and falls into the interior cavity of the tanks 62, 64.

According to other alternative embodiments of the present invention, the nozzles 92, 94 can be positioned outside of and immediately upstream of the tanks 62, 64. If the high pressure supply lines 90 and the nozzles 92, 94 are thermally insulated from the outside environment, the nozzles 92, 94 still can be adequately thermally coupled to the tanks 62, 64. Joule-Thomson expansion of the gas across the nozzles 92, 94 will thus still cool the interior of the tanks 62, 64 during refuelling.

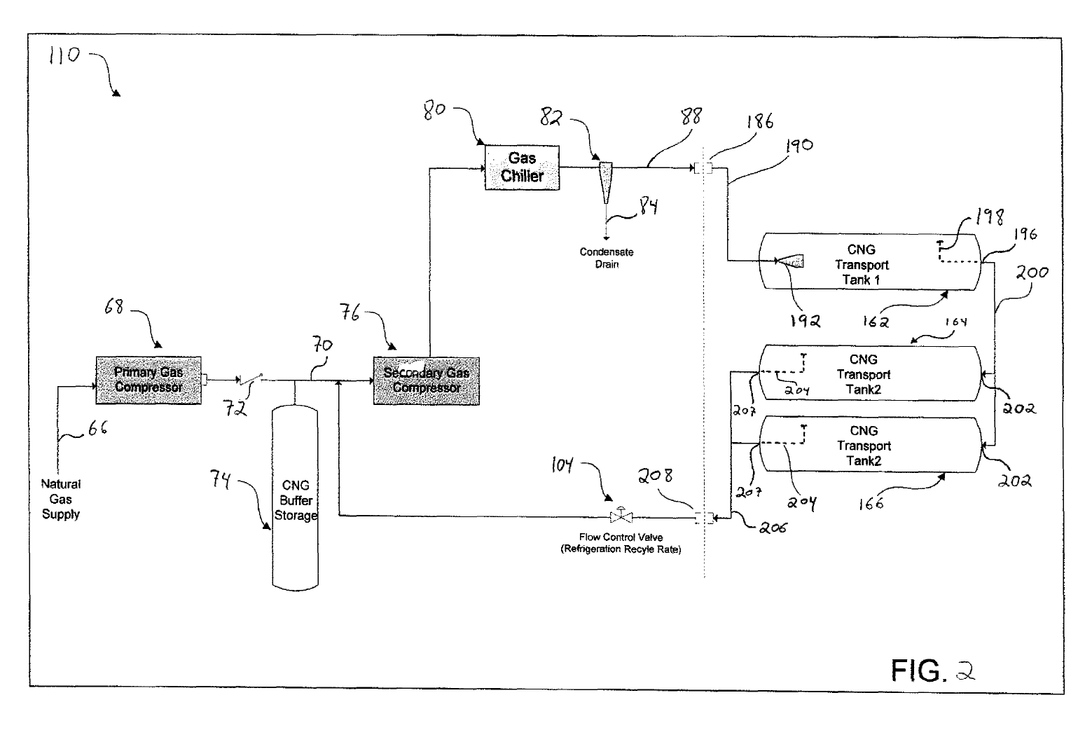

FIG. 2 illustrates a pressure vessel refuelling system 110, including a cooling circuit, which supplies gas at high pressure to CNG transport tanks 162, 164, according to an alternative embodiment of the present invention. The system 110 is similar to the system 60, however as shown the tanks 162, 164 are operated in a horizontal configuration rather in a vertical configuration. Such a horizontal configuration can be more suitable to some gas storage and/or gas transport applications.

An interface 186 is positioned between the supply lines 88 and a supply line 190 that connects directly to the tanks 162, 164. The supply line 190 is connected directly to a nozzle 192 positioned in an interior cavity of the tank 162. Joule-Thomson expansion of the gas thus occurs almost exclusively inside the tank 162, reducing overall gas temperature rises inside the tank 162 due to the heat of compression, as described above.

The cooled gas entering the tank 162 tends to settle and remain at the entry end of the tank 162 and otherwise low in tank 162, whereas the relatively warmer and thus less dense gas already present in the tank 162, tends to rise to the upper of the tank 162 and concentrate at the exit end of tank 162.

The tank 162 further includes a secondary outlet port 196 that is connected to an extension pipe 198 positioned at an upper end of the tank 162 and connected to a gas line 200. The extension pipe 198 ensures that the warmer gas at the exit end of the tank 162 flows into the gas tank 164 via gas line 200 and input port 202.

The gas recycling line 200 is connected to an input port 202 of the tank 164. Temperature stratification of the gas inside the tank 164 also occurs, enabling relatively warmer gas at the upper exit end of the tank 164 to enter an extension pipe 204 that connects to a gas recycling line 206 at an outlet port 207.

As shown, one or more additional tanks 166, similar to or identical to the tank 164, can be included in parallel with the tank 164. The tank 162 is thus connected in series with the one or more tanks 164, 166, which are connected in parallel. That enables modified temperature profiles between the relative volumes of the tank 162 (which is the coldest tank during a fill process) and the one or more additional tanks 164, 166. The increased temperature difference (Delta T) between the temperature of the additional tanks 164, 166 and ambient temperature enables more efficient cooling of the additional tanks 164, 166 during a fill process, which in turn enables a faster and more efficient fill process.

An interface 208, including for example a check valve, bleed valves, etc. then connects the recycling line 206 back to the supply line 70 and to an input of the secondary gas compressor 76, thus completing the cooling circuit.

In summary, advantages of the present invention include enabling fast fill refuelling of CNG fuel tanks by inducing a stratification of gas temperatures inside a tank during refuelling, then re-cycling a portion of the relatively warmer gas out of the tank during refuelling and back to a gas chiller. That reduces the in-tank temperature rise caused by the heat of compression as gas is added to a tank. The system thus enables a tank to be quickly filled to its name plate capacity, with managed temperature rise, eliminating the “partial fill” result of prior art processes for refuelling CNG tanks caused by the heat of compression significantly raising tank temperatures. Further the use of temperature stratification expands heat rejection options, in many cases making possible heat rejection directly to ambient air without the need for cooling towers or expensive refrigeration.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A pressure vessel refuelling system, comprising:
a pressure vessel having a lower end, a first gas port and a second gas port, wherein the second gas port is positioned above the lower end of the pressure vessel; and
a cooling circuit connecting the first gas port with the second gas port;
whereby gas flowing from an interior cavity of the pressure vessel through the second gas port is cooled in the cooling circuit before returning to the pressure vessel through the first gas port; and
whereby a temperature of gas inside the pressure vessel varies from a first temperature at a level of the lower end of the pressure vessel to a second temperature, which is higher than the first temperature, at a level of the second gas port.

2. The pressure vessel refuelling system of claim 1, wherein the cooling circuit includes a plurality of pressure vessels connected in parallel in the circuit.

3. The pressure vessel refuelling system of claim 1, wherein the cooling circuit includes a first pressure vessel connected in series to a plurality of additional pressure vessels connected in parallel in the circuit.

4. The pressure vessel refuelling system of claim 3, wherein the first pressure vessel connected in series includes a nozzle in an interior cavity of the first pressure vessel, and the plurality of additional pressure vessels connected in parallel in the circuit do not include a nozzle in an interior cavity of the additional pressure vessels.

5. The pressure vessel refuelling system of claim 1, wherein the cooling circuit includes a plurality of pressure vessels connected in series in the circuit.

6. The pressure vessel refuelling system of claim 1, wherein an opening to the second gas port is positioned at an upper end of the pressure vessel using an extension pipe positioned inside of the pressure vessel.

7. The pressure vessel refuelling system of claim 1, wherein a nozzle is in fluid communication with the first gas port, whereby the nozzle and the pressure vessel are thermally coupled such that Joule-Thomson expansion of a gas flowing through the nozzle cools the interior cavity of the pressure vessel.

8. The pressure vessel refuelling system of claim 7, wherein the nozzle is a convergent-divergent (CD) nozzle.

9. The pressure vessel refuelling system of claim 7, wherein the nozzle is positioned in the interior cavity of the pressure vessel.

10. The pressure vessel refuelling system of claim 7, wherein the nozzle is positioned in the interior cavity of the pressure vessel and at the lower end of the pressure vessel.

11. The pressure vessel refuelling system of claim 7, wherein the nozzle is positioned in the interior cavity of the pressure vessel and spaced away from the first gas port.

12. The pressure vessel refuelling system of claim 7, wherein the nozzle is positioned outside the interior cavity of the pressure vessel and adjacent the first gas port.

13. The pressure vessel refuelling system of claim 1, wherein the pressure vessel is a compressed natural gas (CNG) vessel.

14. The pressure vessel refuelling system of claim 7, wherein an inlet pressure to the nozzle is maintained at a continuous high pressure to increase Joule-Thomson cooling.

15. The pressure vessel refuelling system of claim 1, wherein the pressure vessel is one of a plurality of pressure vessels used for the transport of compressed natural gas (CNG).

16. The pressure vessel refuelling system of claim 1, wherein the cooling circuit includes a gas chiller.

17. The pressure vessel refuelling system of claim 1, wherein the cooling circuit includes a secondary gas compressor.

18. The pressure vessel refuelling system of claim 1, wherein the cooling circuit includes a flow control valve whereby a gas recycle rate through the pressure vessel is controlled.
